(19) United States
(12) Patent Application Publication
(10) Pub. No.: US 2005/0056233 A1
(43) Pub. Date: Mar. 17, 2005

(54) Folding grooming table step system

(76) Inventors: Kellene O'Leary, Topsfield, MA (US); Nicholas LaRosa, Boxford, MA (US); Kuo-Ho Cheng, Tainan (TW)

Correspondence Address: Iandiorio & Teska, 260 Bear Hill Road, Waltham, MA, 02451-1018, US

(21) Appl. No.: 10/664,250

(22) Filed: Sep. 17, 2003

(51) Int. Cl. A01K 15/04

(52) U.S. Cl. 119/753

(57) ABSTRACT

A folding grooming table step system including a frame with a U-shaped angled forward member forming two spaced legs and a connecting base member, a U-shaped vertically disposed rearward member hinged to the forward member and including two spaced legs connected by a base member, and a connecting rod spanning the two spaced legs of the rearward member. A plurality of wide, deeply offset steps with a low rise are each hingedly connected to the angled forward member. A pair of bracket members are each hingedly connected to the steps and each include an elongated guide channel through which the connecting rod extends to allow the steps and the rearward frame member to fold proximate the forward frame member.

### FIELD OF THE INVENTION

This invention relates to a folding grooming table step system also useful for assisting dogs entering trucks and SUVs and also useful by pet groomers and dog show participants and the like.

### BACKGROUND OF THE INVENTION

Some people who groom dogs own a grooming table with a hydraulic lift system. Such systems, however, are expensive and thus the majority of dog groomers manually lift the dog or other pet onto the grooming table resulting in fatigue and possible medical (e.g., back strain) problems. Typical commercial folding stools cannot be used by pets because the steps are too narrow, are not deep enough, because the rise between each pair of adjacent steps is too high, and because folding stools were not designed to be used with standard grooming tables. Pet ramps are generally heavy and difficult to maneuver.

One known pet step system is not self-standing and instead requires hooks which extend over the edge of a grooming tub.

### SUMMARY OF THE INVENTION

It is therefore an object of this invention to provide a folding grooming table step system.

It is a further object of this invention to provide such a system which is designed to be used in conjunction with standard grooming tables.

It is a further object of this invention to provide such a system which can also be used to transport pets into and out of trucks and SUVs.

It is a further object of this invention to provide such a system which is fairly inexpensive and easy to manufacture.

It is a further object of this invention to provide such a system which reduces groomer fatigue.

It is a further object of this invention to provide such a system which has wide, deep steps with a rise between adjacent steps suitable for pets.

It is a further object of this invention to provide such a system which folds for compact storage and transport.

It is a further object of this invention to provide such a system which is self supporting in the unfolded position.

It is a further object of this invention to provide such a system which is easy to use.

It is a further object of this invention to provide such a system which supports up to 440 lb.

It is a further object of this invention to provide such a system which is constructed of sturdy, slip resistant steps.

The invention results from the realization that a folding step system particularly configured to be used in conjunction with standard grooming tables is effected by the inclusion of wide, deep steps with a low rise hinged to a U-shaped forward frame member itself hinged to a U-shaped rearward frame member forming a stand alone, safe, structurally sound, and inexpensive compactly folding step system with steps offset enough to accommodate even large dogs.

This invention features a folding grooming table step system and SUV/other step system which, in one embodiment, includes a frame comprising a U-shaped angled forward member forming two spaced legs and a connecting base member, a U-shaped vertically disposed rearward member hinged to the forward member and including two spaced legs connected by a base member, and a connecting rod spanning the two spaced legs of the rearward member. There are a plurality of wide, deeply offset steps with a low rise each hingedly connected to the angled forward member and a pair of bracket members each hingedly connected to the steps and each including an elongated guide channel through which the connecting rod extends to allow the steps and the rearward frame member to fold proximate the forward frame member. Typically, each elongated channel includes a detent which releasably locks the connecting rod with respect to the bracket members when the steps and the rearward frame member are unfolded.

The preferred embodiment, there are three steps each wider than 12 inches, each deeper than 6 inches, each having a rise less than 9 inches, and each having an offset greater than 7 inches. Preferably, the width of each step is greater than 14 inches and typically greater than 16 inches. And, it is also preferred that the depth of the steps is greater than 8 inches typically even greater than 10 inches.

In one embodiment, there are bushings between each step and the bracket members. Rubber feet on the bottom of the forward member and the rearward member provide added stability. Also each step preferably includes a grooved rubber covering. The steps are typically constructed of chrome plated steel. In one example, the U-shaped angled forward frame member is square in cross section and the majority of the U-shaped vertically disposed rearward frame member is round in cross section. In the preferred embodiment, the hinged connection between the U-shaped vertically disposed rearward frame member and the U-shaped angled forward frame member comprises a distal tang extending from each leg of the U-shaped vertically disposed rearward frame member each received in a slot formed in each leg of the U-shaped angled forward frame member.

This invention also features a step system comprising an angled forward frame portion; a rearward frame portion hinged to the forward frame portion, and a plurality of wide steps each hingedly connected to the angled forward frame portion, each step wider than 12 inches, deeper than 6 inches, having a rise less than 9 inches, and having an offset between adjacent steps of greater than 7 inches.

Typically, the angled forward frame portion includes two spaced legs. The rearward frame portion also includes two spaced legs. A connecting rod spans the two spaced legs of the rearward member. A pair of bracket members are each hingedly connected to the steps and each include an elongated guide channel through which the connecting rod extends to allow the steps and the rearward frame portion to fold proximate the forward frame portion.

In one embodiment, the folding grooming table step system comprises an angled forward frame portion, a rearward frame portion including spaced legs hinged to the forward frame portion, a connecting rod spanning the two spaced legs of the rearward frame portion, and a plurality of steps each hingedly connected to the angled forward portion. Each step is wider than 12 inches and deeper than 6 inches, each step has a rise less than 9 inches, and an offset greater than 7 inches. A pair of bracket members are each hingedly connected to the steps and each include an elongated guide channel through which the connecting rod extends to allow the steps and the rearward frame portion to fold proximate the forward frame portion.

### BRIEF DESCRIPTION OF THE DRAWINGS

Other objects, features and advantages will occur to those skilled in the art from the following description of a preferred embodiment and the accompanying drawings, in which:

FIG. 1 is a schematic three-dimensional view of a prior art folding stool;

FIG. 2 is a schematic three-dimensional view of a prior art pet step stair system;

FIG. 3 is a three-dimensional front view of one embodiment of the folding grooming table step system in accordance with the subject invention;

FIG. 4 is a schematic three-dimensional side view of the folding grooming table step system shown in FIG. 3;

FIG. 5 is a schematic three-dimensional rear view of the folding grooming table step system showing in FIG. 3;

FIGS. 6-8 are schematic three-dimensional views showing how the grooming table step system of the subject invention folds for compact storage and transport;

FIG. 9 is a schematic three-dimensional bottom view of the folding grooming table step system of FIG. 3;

FIG. 10 is a schematic three-dimensional exploded view showing an example of the hinged interconnection between the forward and rearward frame portions of the folding grooming table step system of the subject invention; and

FIG. 11 is a partial schematic three-dimensional view showing the mechanism which allows the steps to be folded flat for storage and transport in accordance with the subject invention.

### DISCLOSURE OF THE PREFERRED EMOBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

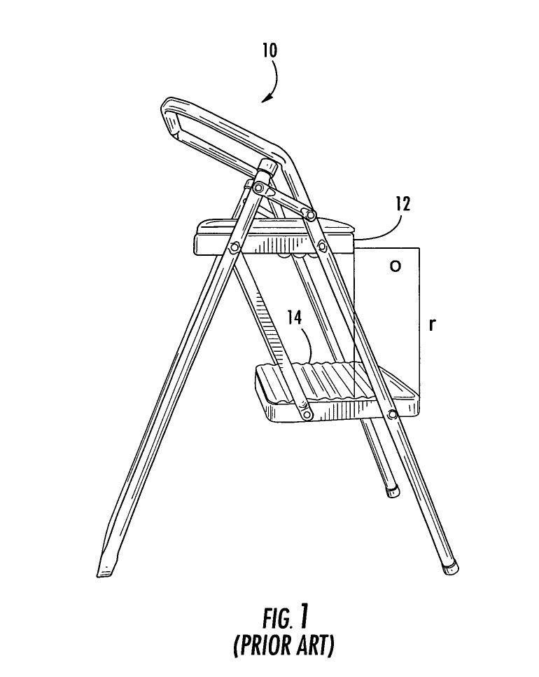

As discussed in a Background section above, conventional folding stool 10, FIG. 1 has steps 12 and 14 which are too narrow, not deep enough, and have too much of a rise (r) and too little of an offset (o) to be used by pets.

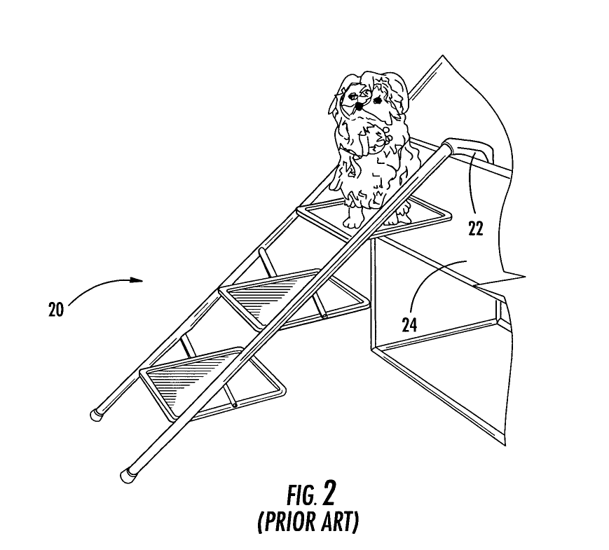

Prior pet step stair 20, FIG. 2 is not self-supporting and instead relies on hooks 22 which extend over the edge of grooming tub 24.

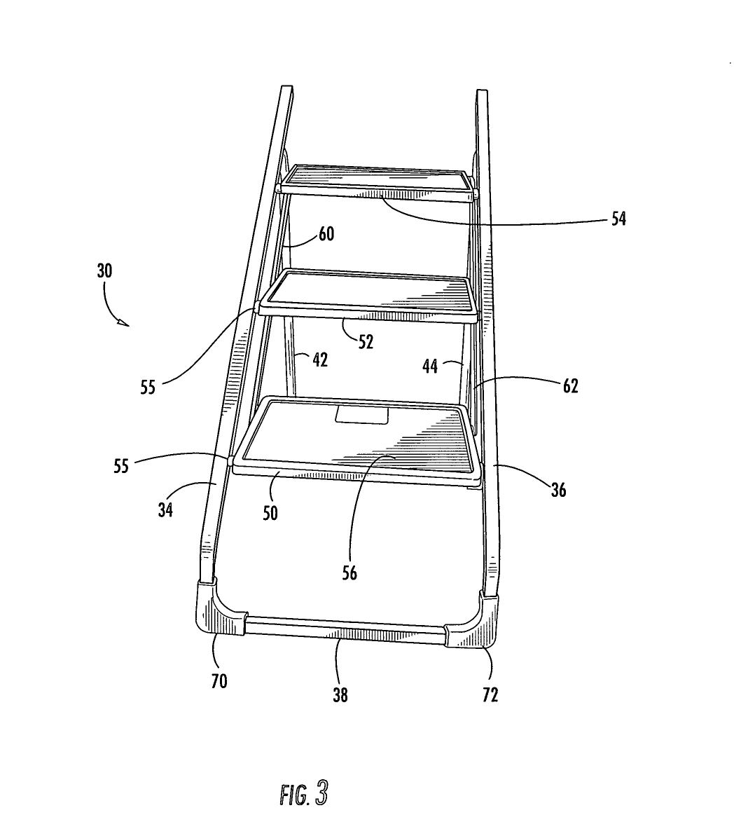

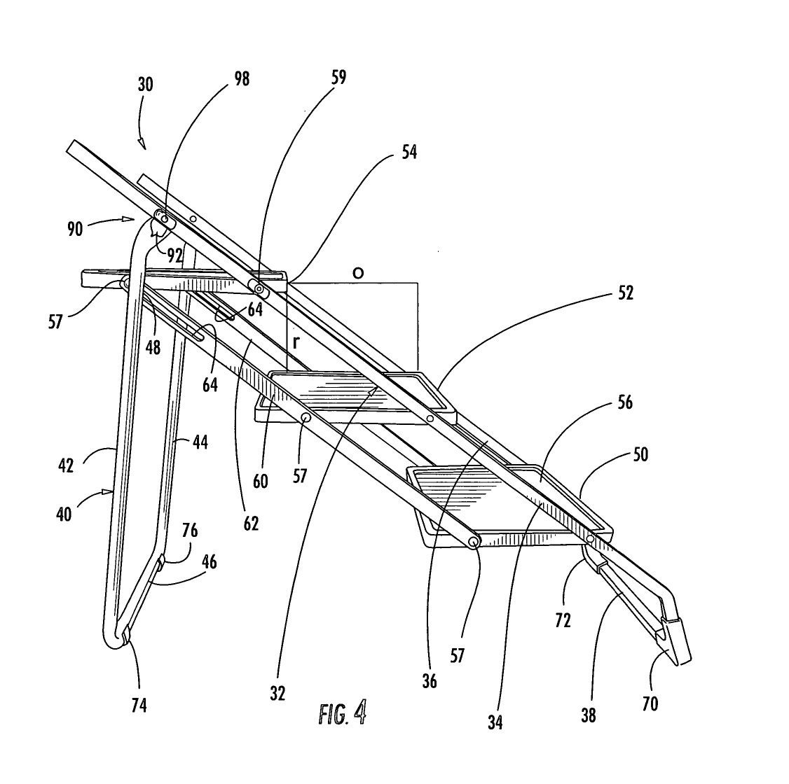

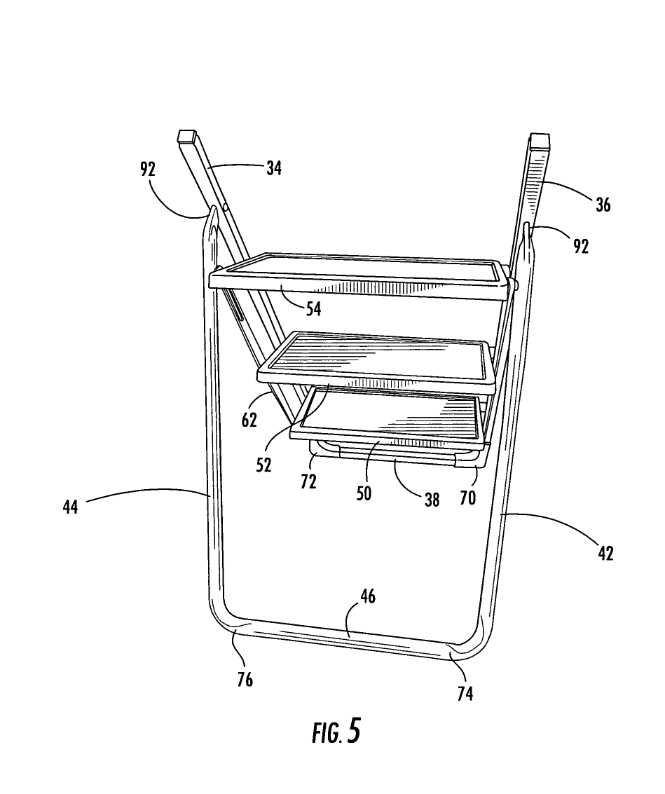

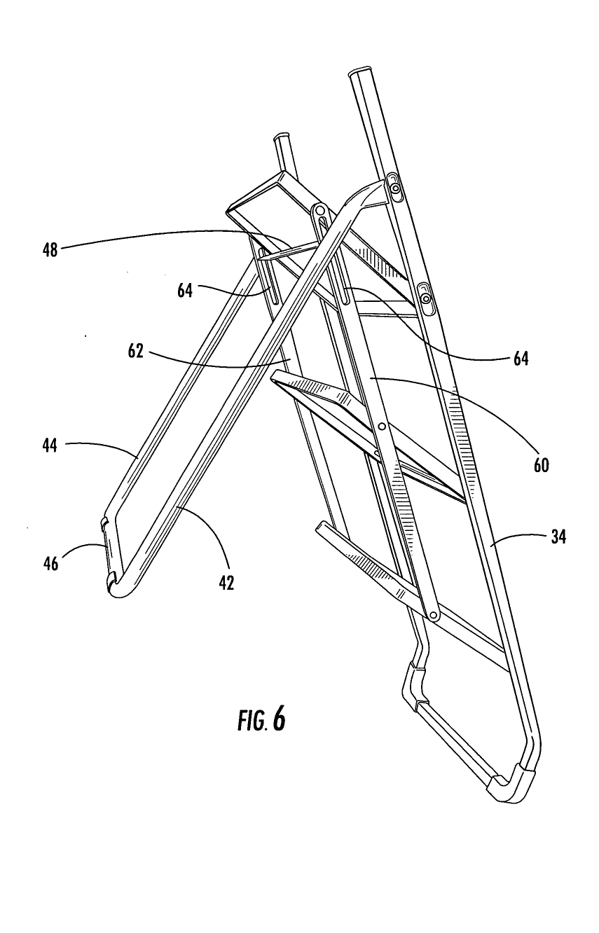

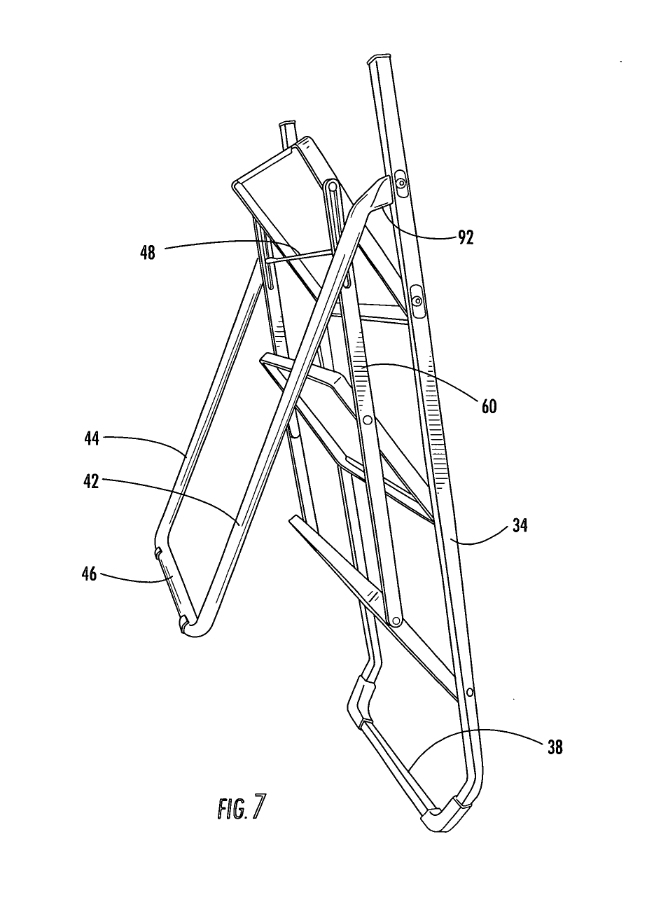

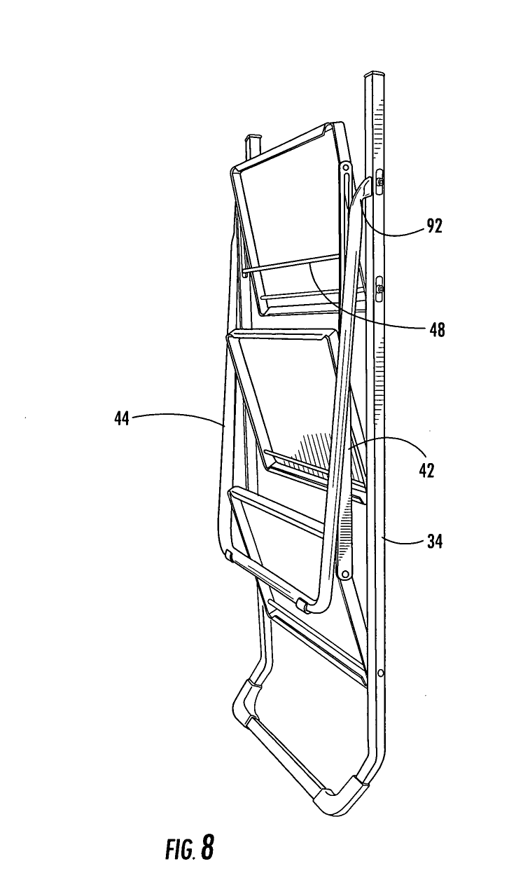

Folding step system 30, FIGS. 3-9, in contrast, was designed particularly for use in connection with a standard grooming table or SUV or other use. In the preferred embodiment shown, U-shaped angled forward frame member 34, FIG. 4 forms two spaced legs 34 and 36 connected by base member 36. U-shaped vertically disposed rearward member 40 is hinged to forward frame member 34 and includes two spaced legs 42 and 44 connected by base member 46. Connecting rod 48 (see also FIGS. 6-9 and 11) spans and interconnects legs 42 and 44.

Chrome plated steel steps 50, 52, and 54 are each typically wider than 12 inches (preferably about 18 inches wide) and deeper than 6 inches (preferably about 11½ inches deep) and include a thick grooved PVC rubber covering 56.

Preferably, the rise (r) of each step as shown in FIG. 4 is 7.5 inches and in any embodiment less than 9.0 inches. The offset (o) of each step is preferably 9 inches and in any embodiment greater than 7 inches. The low rise and deep offset is particularly adapted to pets.

The top step 54 is typically about 24 inches high while the distal ends of leg members 34 and 36 are typically about 31.25 inches high. The distance between base member 46 and base member 48 in the unfolded configuration shown in FIG. 4 is typically about 22.5 inches.

Each step 50, 52, and 54 is hingedly connected to legs 34 and 36 through bushings 55, FIG. 3 and fasteners 59, FIG. 4. Each step 50, 52, and 54 is also hingedly connected to bracket members 60 and 62 by fasteners 57. Each bracket member 60, 62 preferably includes elongated channel 64 through which connecting rod 48 extends to allowing the steps and the rearward frame portion 44 to fold proximate forward member 32 as shown in FIGS. 6-8.

Rubber feet 70 and 72, FIG. 4 on the bottom of forward frame member 32 and rubber feet 74 and 76 on the bottom of rearward frame member 40 prevent slippage and provide added stability.

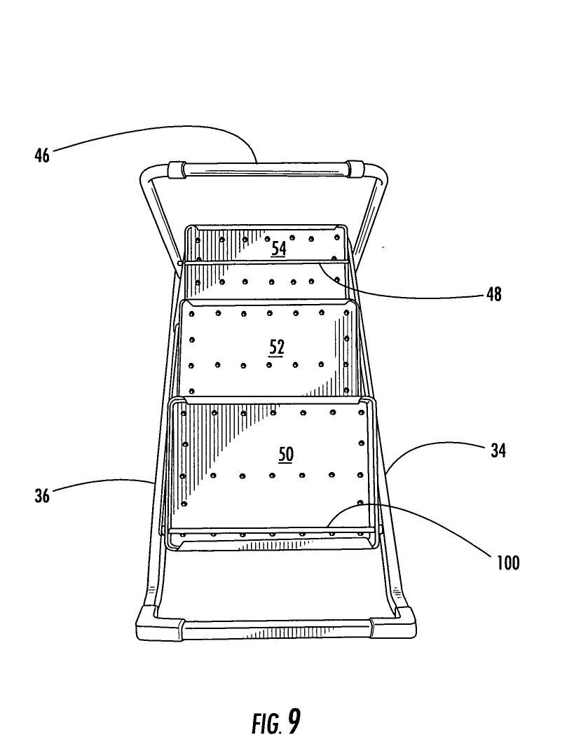

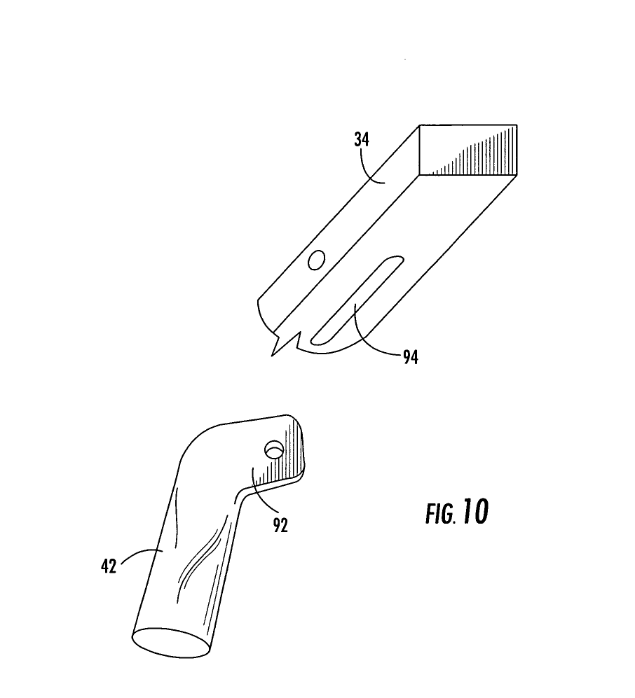

Typically, tubular U-shaped angled forward frame member 32 including legs 34 and 38 and base member 38 is square in cross section and tubular U-shaped rearward frame member 40 including legs 42 and 44 and base member 46 is round in cross section except at hinge area 90 where flat tang 92 is formed at the distal end of each leg 42 and 44. In this way, the hinged connection between legs 42 and 44 and legs 34 and 36 includes tangs 92 received in slot 94 of each leg 34 and 36 of angled frame portion 32 as shown in FIG. 10. Fastener 98, FIG. 4 completes the hinged connection between legs 34 and 36 and legs 42 and 44. Connecting bar 100, FIG. 9 also interconnects legs 34 and 36.

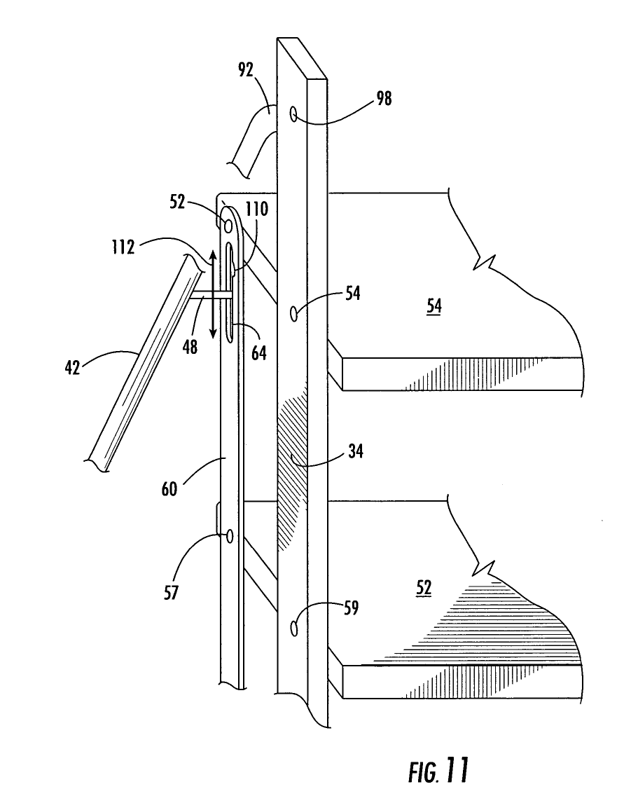

FIG. 6-8 and 11 show how the bracket members 60 and 62 act to fold the steps. FIG. 11 depicts how connecting bar 48 is guided by guide channel 64 in bracket 60 in the direction shown by vector 112. Guide channel 64 includes detent 110 which receives connecting rod 48 releasably locking connecting rod 48 with respect to bracket member 60 when the steps are unfolded.

The result is a folding grooming table step system with wide, deep steps 50, 52, and 54 with a low rise and a deep offset hinged to a U-shaped forward frame member 32 itself hinged to a U-shaped rearward frame member 40 forming a stand alone, safe, structurally sound, and inexpensive compactly folding step system. The step system of the subject invention is designed to be used in conjunction with standard grooming tables but can also be used to transport pets into trucks and SUVs. Folding grooming table step system 30, FIG. 4 can be inexpensively manufactured and marketed. It also reduces groomer fatigue for those dog groomers who cannot afford a hydraulic lift system. The design of the rise, depth, and offset of the steps makes folding grooming table step system 30 suitable for use with a wide variety of different size pets and yet it also folds compactly for storage and transport. It is also fairly lightweight. Unlike the stair system shown in FIG. 2, the folding grooming table step system of the subject invention is self-supporting in the unfolded position as shown in FIGS. 3-5. The prototype design shown in the Figures was able to support up to 440 lbs.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A folding grooming table step system comprising:
a frame including:
a U-shaped angled forward member forming two spaced legs and a connecting base member,
a U-shaped vertically disposed rearward member hinged to the forward member and including two spaced legs connected by a base member, and
a connecting rod spanning the two spaced legs of the rearward member;
a plurality of wide, deeply offset steps with a low rise each hingedly connected to the angled forward member; and
a pair of bracket members each hingedly connected to the steps and each including an elongated guide channel through which the connecting rod extends to allow the steps and the rearward frame member to fold proximate the forward frame member,
each elongated channel including a detent which releasably locks the connecting rod with respect to the bracket members when the steps and the rearward frame member are unfolded.

2. The system of claim 1 in which there are three steps each wider than 12 inches, each deeper than 6 inches, each having a rise less than nine inches, each having an offset greater than seven inches.

3. The system of claim 1 in which the width of each step is greater than 14 inches.

4. The system of claim 1 in which the width of each step is greater than 16 inches.

5. The system of claim 1 in which the offset between adjacent steps is greater than seven inches.

6. The system of claim 1 in which the depth of the steps is greater than 8 inches.

7. The system of claim 1 in which the depth of the steps is greater than 10 inches.

8. The system of claim 1 in which the rise of the steps is less than nine inches.

9. The system of claim 1 in which there are bushings between each step and the bracket members.

10. The system of claim 1 in which further including rubber feet on the bottom of the forward member and the rearward member.

11. The system of claim 1 in which each step include a grooved rubber covering.

12. The system of claim 1 in which the steps are constructed of chrome plated steel.

13. The system of claim 1 in which the U-shaped angled forward frame member is square in cross section.

14. The system of claim 1 in which the majority of the U-shaped vertically disposed rearward frame member is round in cross section.

15. The system of claim 1 in which the hinged connection between the U-shaped vertically disposed rearward frame member and the U-shaped angled forward frame member comprises a distal tang extending from each leg of the U-shaped vertically disposed rearward frame member each received in a slot formed in each leg of the U-shaped angled forward frame member

16. A step system comprising:
an angled forward frame portion;
a rearward frame portion hinged to the forward frame portion; and
a plurality of steps each hingedly connected to the angled forward frame portion, each step wider than 12 inches, deeper than 6 inches, having a rise less than 9 inches, and having an offset between adjacent steps greater than 7 inches.

17. The system of claim 16 in which the angled forward frame portion includes two spaced legs.

18. The system of claim 16 in which the rearward frame portion includes two spaced legs.

19. The system of claim 18 further including a connecting rod spanning the two spaced legs of the rearward frame portion.

20. The system of claim 19 further including a pair of bracket members each hingedly connected to the steps and each including an elongated guide channel through which the connecting rod extends to allow the steps and the rearward frame portion to fold proximate the forward frame portion.

21. A folding grooming table step system comprising:
a frame including:
an angled forward frame portion,
a rearward frame portion including spaced legs hinged to the forward frame portion,
a connecting rod spanning the two spaced legs of the rearward frame portion;
a plurality of steps each hingedly connected to the angled forward portion, each step wider than 12 inches and deeper than 6 inches, each step having a rise less than 9 inches and an offset greater than 7 inches; and
a pair of bracket members each hingedly connected to the steps and each including an elongated guide channel through which the connecting rod extends to allow the steps and the rearward frame portion to fold proximate the forward frame portion.

22. The system of claim 21 in which the angled forward frame portion includes two spaced legs and a connecting base member.

23. The system of claim 21 in which the rearward frame portion includes a base member connecting the two spaced legs.

24. A folding grooming table step system comprising:
a U-shaped angled forward member forming two space legs and a connecting base member;
a U-shaped vertically disposed rearward member hinged to the forward member and including two spaced legs connected by a base member;
a connecting rod spanning the two spaced legs of the rearward member;
a plurality of steps each hingedly connected to the angled forward member; and
a pair of bracket members each hingedly connected to opposite sides of the steps and each including an elongated guide channel through which the connecting rod extends to allow the steps and the rearward member to fold proximate the forward member

25. A folding step system comprising:
a foldable frame:
three wide steps each hingedly connected to the foldable frame, each step wider than 12 inches, deeper than 6 inches, having a rise less than 9 inches, and each adjacent step offset by a distance greater than 7 inches, the top step being at least 24 inches high.
